(19) United States
(12) Patent Application Publication
(10) Pub. No.: US 2026/0071658 A1
(43) Pub. Date: Mar. 12, 2026

(54) BRAKE PAD

(71) Applicants: HYUNDAI MOTOR COMPANY, Seoul (KR); KIA CORPORATION, Seoul (KR)

(72) Inventors: Jung Ro Yoon, Hwaseong-si (KR); Sung Hyun Cho, Hwaseong-si (KR); Jeong Kyu Kim, Hwaseong-si (KR)

(73) Assignees: HYUNDAI MOTOR COMPANY, Seoul (KR); KIA CORPORATION, Seoul (KR)

(21) Appl. No.: 19/199,078

(22) Filed: May 5, 2025

(30) Foreign Application Priority Data
Sep. 9, 2024 (KR) 10-2024-0122532

(51) Int. Cl. F16D 65/00; B32B 15/06; B32B 27/20; B32B 27/40; F16D 65/092; F16D 65/847

(52) U.S. Cl. CPC F16D 65/0006; B32B 15/06; B32B 27/20; B32B 27/40; F16D 65/092; F16D 65/847; B32B 2264/1027; B32B 2307/302; B32B 2307/51; B32B 2307/56; B32B 2307/744; B32B 2605/00; F16D 2200/0056

(57) ABSTRACT

A brake pad includes a back plate to be installed on a brake caliper and defining a base. The brake pad also includes a frictional material stacked at a first surface of the back plate to generate friction with a brake disc. At least one of the frictional material or the back plate includes a groove for suppressing waves generated by the brake pad.

### CROSS-REFERENCE TO RELATED APPLICATION

This application claims the benefit of priority to Korean Patent Application No. 10-2024-0122532, filed in the Korean Intellectual Property Office on Sep. 9, 2024, the entire contents of which are incorporated herein by reference.

### TECHNICAL FIELD

The present disclosure relates to a brake pad, and more particularly, to a technology for suppressing a reflected wave of a brake pad.

### BACKGROUND

A braking device for a vehicle is a device that performs a braking operation by converting rotational kinetic energy of wheels into thermal energy through a brake pad. Therefore, resonance occurs in the braking device due to exciting energy of the brake pad. If the resonance exceeds a damping limit of a system, noise may occur.

Here, if the noise corresponds to a frequency range of 1 kHz to 16 kHz, the noise is squeal noise, and sound is unpleasant, which is a major complaint of users. However, even if it is designed to prevent the squeal noise of the braking device during development testing, a lining of the brake pad included in the braking device wears out over time. Also, vibration characteristics of the braking device are changed. Thus, noise that has not occurred during the development testing may occur.

### SUMMARY

To solve this problem, it is advantageous to develop a technology to suppress reflected waves generated during braking of the brake pad, to couple a brake noise preventing member to a back plate of the brake pad, and thus to reduce braking friction noise.

The present disclosure has been made to solve the above-mentioned problems occurring in the prior art while advantages achieved by the prior art are maintained intact.

An aspect of the present disclosure provides a brake pad capable of suppressing squeal noise and reflected waves of a brake by providing the brake pad processed into a curve based on a first function for suppressing reflected waves and a second function for cooling.

The technical problems to be solved by the present disclosure are not limited to the aforementioned problems. Any other technical problems not mentioned herein should be more clearly understood from the following description by those of ordinary skill in the art to which the present disclosure pertains.

According to an aspect of the present disclosure, a brake pad is provided. The brake pad includes a back plate to be installed on a brake caliper and forming a base and includes a frictional material stacked on a first surface of the back plate and positioned to generate friction with a brake disc. At least one of the frictional material or the back plate includes a groove for suppressing waves generated by the brake pad.

In an embodiment, the frictional material may include at least one inner groove recessed in a disc contacting surface of the frictional material in a direction toward the back plate. The back plate may include at least one outer groove including a shape recessed in a second surface of the back plate in the direction toward the frictional material.

In an embodiment, each of the inner groove and the outer groove may include at least one of a first curve corresponding to a predetermined function, a second curve different from the first curve, or a linear line, or any combination thereof.

In an embodiment, the first curve may be determined based on a first function for suppressing reflected waves in the brake pad.

In an embodiment, the first curve may be determined based on a second function for cooling the brake pad.

In an embodiment, the frictional material may be shaped such that a perimeter edge of the disc contacting surface of the frictional material is located closer to a center of the brake pad than a perimeter edge of the back plate contacting surface of the frictional material on one side surface and the other side surface of the frictional material.

In an embodiment, the back plate may be shaped such that a perimeter edge of a second surface of the back plate is located closer to a center of the brake pad than a perimeter edge of the first surface of the back plate on one side surface and the other side surface of the back plate.

In an embodiment, the back plate may include a viscoelastic layer that is stacked on the second surface of the back plate and that reduces vibration of the back plate.

In an embodiment, the viscoelastic layer may include at least one of a viscoelastic layer made of rubber or a viscoelastic layer made of polyurethane, or any combination thereof.

In an embodiment, the viscoelastic layer made of rubber may include a layer including an adhesive, rubber, and a metal.

In an embodiment, the viscoelastic layer made of polyurethane may include a layer including an adhesive, polyurethane, and nanoclay.

### BRIEF DESCRIPTION OF THE DRAWINGS

The above and other objects, features, and advantages of the present disclosure should be more apparent from the following detailed description taken in conjunction with the accompanying drawings in which:

FIG. 1 is a diagram illustrating a configuration of a brake pad mounted on a brake caliper in a brake apparatus according to an embodiment of the present disclosure;

FIG. 2 is a view illustrating a configuration of a frictional material in a brake pad according to an embodiment of the present disclosure;

FIG. 3 is a view illustrating a configuration of a back plate in a brake pad according to an embodiment of the present disclosure;

FIG. 4 is a view illustrating the configuration of a back plate in a brake pad according to an embodiment of the present disclosure;

FIG. 5 is a view illustrating a groove in a brake pad according to an embodiment of the present disclosure;

FIG. 6 is a side view of a brake pad according to an embodiment of the present disclosure;

FIG. 7 is a perspective view of a brake pad according to an embodiment of the present disclosure; and

FIG. 8 is a perspective view of a brake pad according to an embodiment of the present disclosure.

In connection with the description of the drawings, the same or similar components may be designated by the same or similar reference numerals.

### DETAILED DESCRIPTION

Hereinafter, some embodiments of the present disclosure are described in detail with reference to the drawings. In adding reference numerals to components of each drawing, it should be noted that identical or equivalent components are designated by an identical numeral even if they are displayed on other drawings. Further, in describing the embodiments of the present disclosure, a detailed description of the related known configurations or functions has been omitted where it was determined that the detailed description would have interfered with the understanding of the embodiments of the present disclosure. In particular, various embodiments of the present disclosure are described with reference to the accompanying drawings. Accordingly, those of ordinary skill in the art should recognize that modifications, equivalents, and/or alternatives on the various embodiments described herein may be variously made without departing from the scope and spirit of the disclosure. With regard to the description of drawings, similar components may be denoted by similar reference numerals.

Further, in describing the components of the embodiments of the present disclosure, terms, such as first, second, “A”, “B”, (a), and (b) may be used. These terms are merely intended to distinguish one component from other components, and the terms do not limit the nature, order, or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and will not be interpreted in an idealized or overly formal sense unless expressly so defined herein. For example, expressions, such as “a first,” “a second,” “the first,” or “the second,” used in the present disclosure refer to various components regardless of order and/or importance. Such expressions may be only used to distinguish one component from another component and do not limit the components. For example, a first user device and a second user device may refer to different user devices regardless of sequence or importance. For example, a first component may be renamed a second component without departing from the scope of rights described in the present disclosure, and similarly, a second component may also be renamed a first component.

In the present disclosure, expressions, such as “have,” “may have,” “includes,” or “may include” indicate the presence of the corresponding feature (e.g., a numerical value, a function, an operation, or a component such as a part), and does not rule out the presence of additional features.

Where it is mentioned that a certain component (e.g., a first component) is “(functionally or communicatively) coupled with/to” or “connected” to another component (e.g., a second component), it should be understood that the certain component may be connected directly to the other component or may be connected through another component (e.g., a third component). On the other hand, where it is mentioned that a component (e.g., a first component) is “directly connected” or “directly electrically connected” to another component (e.g., a second component), it may be understood that there is no component (e.g., a third component) between the component and the other component.

The expression “configured to” used in the present disclosure may be used as, depending on the context, for example, “suitable for,” “having the capacity to”, “designed to,” “adapted to,” “made to,” or “capable of.”

The term “configured (or set to)” may not necessarily mean “specifically designed to” in hardware. Instead, in some situations, the expression “device configured to” may mean that the device is “capable of” working with other devices or components. Terms used herein are merely used to describe specific embodiments and may not be intended to limit the scope of other embodiments. Singular expressions may include plural expressions unless clearly otherwise indicated in the context. Terms used herein including technical or scientific terms have the same meanings as those commonly understood by those having ordinary skill in the art disclosed in the present document. Terms defined in a general dictionary among the terms used herein may be interpreted as the same or similar meanings as the meanings in the context of the related art and are not interpreted as ideal or excessively formal meanings unless explicitly defined herein. In some cases, even terms defined herein may not be interpreted to exclude embodiments of the present document.

In the present disclosure, expressions, such as “A or B,” “at least one of A or/and B,” or “one or more of A or/and B”, may include all possible combinations of the items listed together. For example, “A or B,” “at least one of A and B,” or “at least one of A or B” (1) may include at least one A, (2) may include at least one B, or (3) may refer to all cases including both at least one A and at least one B. Additionally, in describing the components of the embodiments of the present disclosure, phrases, such as “A or B”, “at least one of A and B”, “at least one of A or B”, “A, B or C”, “A, B, and C,” “at least one of A, B, or C,” and “at least one of A, B, C, or any combination thereof,” may include any one of the items listed together, or any possible combination of them. In particular, phrases, such as “at least one of A, B, or C, or any combination thereof”, may include A or B or C or a combination thereof such as AB or ABC.

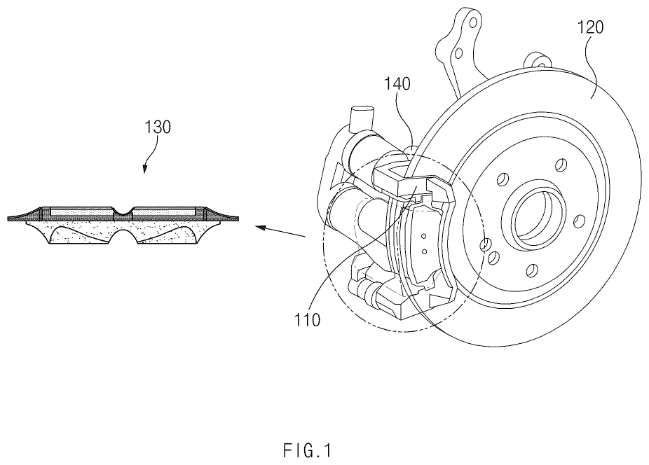

Hereinafter, embodiments of the present disclosure are described in detail with reference to FIGS. 1-8.

FIG. 1 is a diagram illustrating a configuration of a general brake pad mounted on a brake caliper in a brake assembly according to an embodiment of the present disclosure.

As illustrated in FIG. 1, a brake caliper 110 is configured such that a brake pad 130 for holding a disc 120 is mounted inside a housing 140. As compared to a drum-type braking device, a disc-type braking device employing the brake caliper 110 has advantages in that a disc and a pad are exposed to the outside. Thus, the disc and pad are quickly cooled, expansion is performed in an outward direction even if the brake pad 130 is thermally expanded, and thus there is no gap between the brake pad 130 and the disc 120.

However, if a driver presses a brake pedal, a vehicle equipped with the brake caliper 110 may be braked due to friction between the disc 120 and the brake pad 130. In this case, braking friction noise may be generated due to the friction between the disc 120 and the brake pad 130. The braking friction noise may be generated as waves are propagated in a circumferential direction due to the friction between the disc 120 and the brake pad 130. The propagated waves serve as an excitation source. Here, the brake pad 130 may delay and dissipate the propagation of the waves, which may be generated, through application of a reflected wave suppressing member. The brake pad 130 may finally decrease the braking friction noise through a decrease in an excitation force of the excitation source.

In a pad-based braking friction noise reducing method according to the related art, there are improvement methods such as chamfering and/or slot processing in a lining or brake shim application. In the lining chamfer and/or slot method, the braking friction noise may be reduced through improvement of surface pressure distribution or mode change of the brake pad 130. Also, in the brake shim application method, the braking friction noise may be reduced by improving a damping force of the brake pad 130 itself. However, in the above-described conventional method, it is difficult to achieve noise reduction robustness in various environments. Also, an increase in costs may be caused due to application of a high-damping brake shim to additionally secure robust designs.

The brake pad 130 may reduce a vibration amplitude of the excitation source itself and may dually trap and dissipate waves propagating in a longitudinal direction and a transverse direction. Accordingly, the brake pad 130 may expect an effect of maximizing a reduction in the excitation source and an effect of reducing noise at a final response source.

If the driver presses the brake pedal for braking, the brake pad 130 may perform forward movement through brake hydraulic pressure. Here, a braking situation of the vehicle may occur due to the friction between the brake pad 130 and the disc 120. In the braking situation, the waves may be generated in the longitudinal direction and the transverse direction due to the friction between the brake pad 130 and the disc 120 and may serve as an excitation source of braking noise. Solid waves due to friction excitation may be propagated in a longitudinal and transverse area with respect to a frictional material and in a longitudinal and transverse area with respect to a back plate. A wave number, an amplitude, and a speed may be the same in the corresponding areas. For propagation delay and absorption of the solid waves, a form of power function processing may be generated inside the brake pad 130. Additionally, trapped waves may be dissipated due to a viscoelastic layer of the back plate. Due to the reduction in the excitation source, a reduction in frictional noise in the brake pad 130 may be finally implemented.

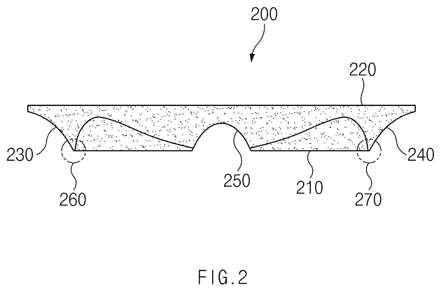

FIG. 2 is a view illustrating a configuration of a frictional material in the brake pad according to an embodiment of the present disclosure.

FIG. 2 is a diagram illustrating a frictional material 200 in the brake pad 130. For example, the brake pad 130 may include the frictional material 200. The brake pad 130 may include the back plate installed on the brake caliper 110 and forming a base and may include the frictional material 200 stacked on a first surface of the back plate to generate friction with the disc 120. In the below description, terms such as upper, lower, vertical, end, left, right, and the like are used merely with reference to the orientation of the brake pad 130 depicted in the drawings. These terms are used merely to distinguish among different surfaces, faces, sides, ends, or the like of the components.

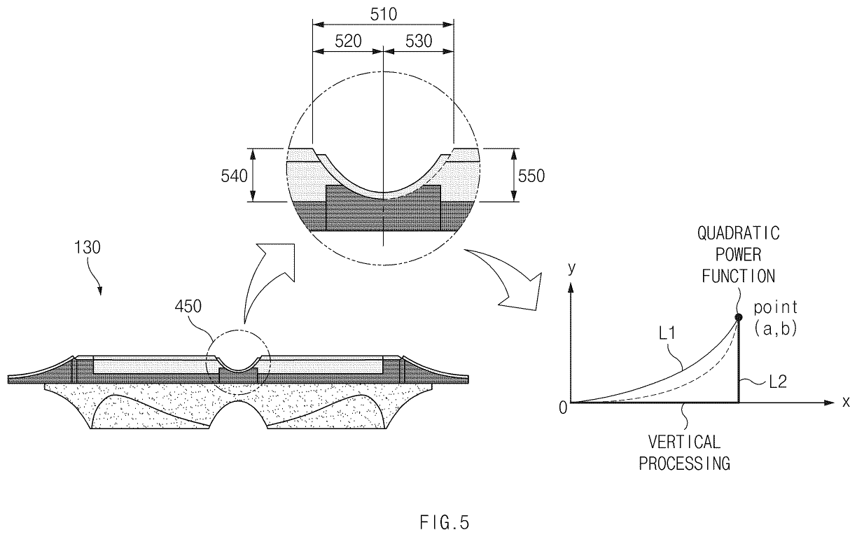

The frictional material 200 may include at least one inner groove 250 including a shape in which the inner groove 250 in a lower (relative to the drawing) surface 210, i.e., the exposed disc contacting surface, of the frictional material 200 is recessed in a direction toward a back plate 300 or toward an upper (relative to the drawing) surface 220, i.e., the back plate contacting surface, of the frictional material 200. For example, the shape of the inner groove 250 may include at least one of a first curve corresponding to a predetermined function, a second curve different from the first curve, or a linear line, or any combination thereof. For reference, a detailed description of the inner groove 250 is provided in detail with respect to FIG. 5 below.

The frictional material 200 may vertically (relative to the drawing) extend such that the lower surface 210 of the frictional material 200 is located on an inside, i.e., inner or interior, closer to a center of the brake pad 130 than the upper surface 220 of the frictional material 200 on one side, i.e., end, surface 230 and the other side, i.e., end, surface 240 of the frictional material 200. In other words, the side or end surfaces 230 and 240 of the friction material 200 may be tapered or angled so that the lower or disc contacting surface 210 has a smaller surface area than the upper or back plate contacting surface 220. For example, referring to the one side surface 230, a first point 260 on the perimeter edge of the lower surface 210 may be located closer to the center of the brake pad 130 than an end point on the perimeter edge of the upper surface 220 (i.e., a point adjacent to the first point among end points of the upper surface 220). Referring to the other side surface 240, a second point 270 on the perimeter edge of the lower surface 210 may be located closer to the center of the brake pad 130 than an end point on the perimeter edge of the upper surface 220 (i.e., a point adjacent to the second point among the end points of the upper surface 220).

The one side surface 230 and the other side surface 240 may include a shape that includes a portion of a curve including a power function structure. For example, the one side surface 230 and the other side surface 240 may include a portion of the inner groove 250 that may include at least one of the first curve corresponding to the predetermined function, the second curve different from the first curve, or the linear line, or any combination thereof.

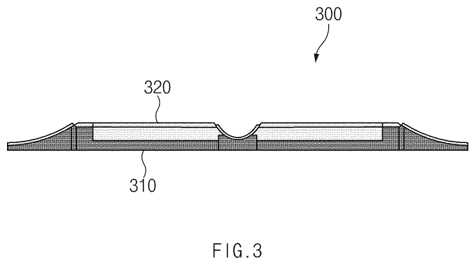

FIG. 3 is a view illustrating a configuration of a back plate in a brake pad according to an embodiment of the present disclosure.

FIG. 3 is a diagram illustrating a back plate 300 in the brake pad 130. For example, the brake pad 130 may include the back plate 300. The brake pad 130 may include the back plate 300 installed on the brake caliper 110 and may form a base and may include the frictional material 200 stacked on a lower (relative to the drawing) surface, i.e., a first or material attachment surface, of the back plate 300 to generate the friction with the disc 120.

The back plate 300 may include a viscoelastic layer 320 that is stacked on an upper (relative to the drawing) end, i.e., the second, outer, or opposite surface, of the back plate 300 and reduces vibration of the back plate 300. For example, the viscoelastic layer 320 may include at least one of the viscoelastic layer 320 made of rubber or the viscoelastic layer 320 made of polyurethane, or any combination thereof. In detail, the back plate 300 may include an upper (relative to the drawing) layer, i.e., an outer or first layer, and may include a lower (relative to the drawing) layer, i.e., an inner or second layer. The upper layer included in the back plate 300 may represent the viscoelastic layer 320. The viscoelastic layer 320 of the back plate 300 may be stacked on an upper (relative to the drawing) end, i.e., an outer surface, of a lower layer 310 of the back plate 300.

The viscoelastic layer 320 made of rubber may include a layer including an adhesive, rubber, and a metal. The viscoelastic layer 320 made of polyurethane may include a layer including an adhesive, polyurethane, and nanoclay.

In one example, a viscoelastic material may refer to a material that includes both viscous properties and elastic properties. An elastic material may move along a linear line in which a stress-strain behavior of an object during a tension/compression process and a process of restoration to an original state is always constant. The viscoelastic material may follow different stress-strain curves if tensioned or compressed or restored to an original state. The viscoelastic material may dissipate energy by an area corresponding to a difference between the stress-strain curves. The viscoelastic layer 320 may mainly include four layers including an adhesive-rubber-metal-rubber adhesive and may include viscoelastic properties due to the rubber and the adhesive. In other words, the back plate 300 may include a member in which the viscoelastic layer 320 is a material thereof and a member in which a composite component of the viscoelastic layer 320 is a material thereof. The member in which the viscoelastic layer is the material may include the viscoelastic layer 320 made of rubber and the viscoelastic layer 320 made of a polymer resin. The member in which the composite component of the viscoelastic layer 320 is the material thereof may include the viscoelastic layer 320 including an adhesive-rubber-metal layer and the viscoelastic layer 320 including an adhesive-polyurethane (polymer resin)-nanoclay layer.

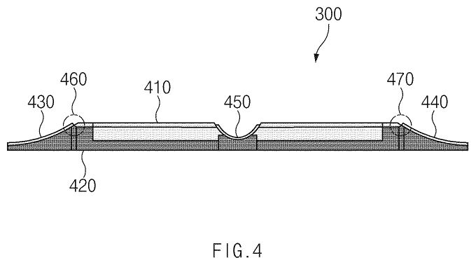

FIG. 4 is a view illustrating the configuration of a back plate in a brake pad according to an embodiment of the present disclosure.

The back plate 300 may include at least one outer groove 450 including a shape in which the outer groove 450 in an upper (relative to the drawing) surface 410, i.e., the outer or opposite surface, of the back plate 300 is recessed in a direction toward the upper surface 220 of the frictional material 200. The outer groove 450 may include at least one of the first curve corresponding to the predetermined function, the second curve different from the first curve, or the linear line, or any combination thereof. For reference, a detailed description of the outer groove 450 is provided in detail with reference to FIG. 5 below.

The back plate 300 may vertically extend such that the upper (relative to the drawing) surface 410, i.e., the outer or opposite surface, of the back plate 300 is located on an inside closer to the center of the brake pad 130 than a lower (relative to the drawing) surface 420, i.e., the material attachment surface, of the back plate 300 on one side surface 430, i.e., end or edge, and the other side surface 440, i.e., end or edge, of the back plate 300.

For example, referring to the one side surface 430, a first point or edge 460 of the upper surface 410 may be located closer to the center of the brake pad 130 than an end point or edge of the lower surface 420 (i.e., a point adjacent to the first point among end points of the lower surface 420). Referring to the other side surface 440, a second point or edge 470 of the upper surface 410 may be located closer to the center of the brake pad 130 than an end point or edge of the lower surface 420 (i.e., a point adjacent to the second point among the end points of the lower surface 420).

The one side surface 430 and the other side surface 440 may include a shape that includes a portion of a curve including a power function structure. For example, the one side surface 430 and the other side surface 440 may include a portion of the outer groove 450 that may include at least one of the first curve corresponding to the predetermined function, the second curve different from the first curve, or the linear line, or any combination thereof.

FIG. 5 is a view illustrating a groove in the brake pad according to the embodiment of the present disclosure.

Referring to FIG. 5, a description of the outer groove 450 is illustrated. For example, the outer groove 450 may be formed having a size or width 510, which is a total width, within a range in which rigidity of the brake pad 130 may be secured. The outer groove 450 may be formed in a shape that is symmetrical in a leftward/rightward, i.e., widthwise direction or may be formed in a shape that is asymmetrical in the leftward/rightward, i.e., widthwise direction with respect to the center of the outer groove 450. In one example, if the outer groove 450 is formed in a shape that is asymmetric in the leftward/rightward or widthwise direction, a result obtained by summing a size or width 520 of one axial side of the groove 450 and a size or width 530 of the other axial side of the groove 450 may be the same as the length 510, though the dimensions 520 and 530 are different from one another. Also, a height or thickness 540 of the material on one side of the groove 450 and a height or thickness 550 of the material on the other side of the outer groove 450 may be set by a designer of the outer groove 450. In detail, the designer may set the height or thickness 540 and the height or thickness 550 in consideration of noise reduction of the brake pad 130 and cooling of the brake pad 130. In addition, the above description of the outer groove 450 may also be applied to the inner groove 250 of the frictional material 200.

An effect of suppressing reflected waves according to a curve (e.g., at least one of the inner groove 250, the outer groove 450, the one side surface 230 and the other side surface 240 of the frictional material 200, and the one side surface 430 and the other side surface 440 of the back plate 300) included in the brake pad 130 may be described by Equations 1 and 2 below.

$$k = {( \frac{3 {df}^{2}}{{Ec}^{2}} )}^{1 / 4} \cdot \frac{1}{{x}^{n / 2}} \qquad [ Equation 1 ]$$

In Equation 1, txⁿ may mean the shape or profile of a beam (e.g., groove) following a power function, ‘d’ may mean the density of the beam, ‘E’ may mean the Young's modulus of the beam, ‘f’ may mean an angular frequency of a bent wave, and ‘K’ may mean the wave number of a beam's bent wave of a power function processing surface.

$$T = \frac{1}{2 {m}^{1 / 2}} {( \frac{3 d}{{Ef}^{2}} )}^{1 / 4} \cdot {\int }_{{x}_{1}}^{{x}_{2}} {x}^{- n / 2} dx \qquad [ Equation 2 ]$$

In Equation 2, x₁, x₂ may mean predetermined two points in the power function beam and ‘T’ may mean a time required for wave propagation of the power function processing surface. In other words, Equation 2 may include the meaning that a travel time of the waves increases as a speed of the waves decreases under the same travel distance. A wave delay phenomenon of the waves may be described through Equation 2.

A cooling process of the brake pad 130 may include heat transfer forms such as conduction, convection, and radiation. The cooling process due to convection may include a phenomenon in which a surface of the brake pad 130 is moved and cooled due to a temperature difference with outdoor air and may be expressed by Equation 3 below.

$${q}_{c} = hA Δ T \qquad [ Equation 3 ]$$

In Equation 3, q_{c} may mean a cooling heat transfer rate due to convection, ‘h’ may mean a coefficient of cooling convection, ‘A’ may mean a convection area, and ΔT may mean a temperature difference between outside air and the surface of the brake pad 130.

The cooling process due to the radiation may include a phenomenon in which atoms on the surface of the brake pad 130 are excited by heat and cooled while radiating electromagnetic waves to the outdoor air and may be expressed by Equation 4 below.

$${q}_{γ} = εσ {AT}_{s}^{4} \qquad [ Equation 4 ]$$

In Equation 4, qᵣ may mean a cooling heat transfer rate due to radiation, ε may mean a radiation emissivity, o may mean a Stefan-Boltzmann constant, and Ts may mean a temperature of the surface of the brake pad 130.

To suppress reflected waves in the brake pad 130, the curve included in the brake pad 130 may be determined based on a power function. In detail, the power function may be used to determine the first curved line. For example, the power function may be expressed by Equation 5 below.

$$y = {mx}^{n} ( n \geq 2 ) \qquad [ Equation 5 ]$$

In Equation 5, (x, y) may be included in the graph illustrated in FIG. 5 and (m, n) may mean a coefficient for deriving the power function.

For example, a target point (e.g., (a, b)) may indicate a point included in the curve. The target point may be expressed as a position of (a, b) in the graph illustrated in FIG. 5. Applying the target point to a graph illustrated in FIG. 5 may be expressed by Equation 6 below.

$$b = {ma}^{n} \qquad [ Equation 6 ]$$

In Equation 6, the target point may mean a state of being applied to the power function expressed in Equation 5.

The first curved line may be determined as a curved line that may be expressed by the power function. In detail, if the power function expressed in Equation 6 is a quadratic function (e.g., if n is 2), the brake pad 130 may have excellent suppression of the reflected waves and/or low-frequency waves. Further, in terms of cooling of the brake pad 130, as a surface area increases, thermal convection and radiation may be predominant. In other words, the first curved line may be determined by a first function for suppressing reflected waves and/or low-frequency waves from the brake pad 130 and a second function for cooling the brake pad 130. The first function may be expressed by Equation 7 below and the second function may be expressed by Equation 8 below.

$${L}_{1} = {\int }_{0}^{a} \sqrt{1 + {( 2 {m}_{2} x )}^{2}} dx \qquad [ Equation 7 ]$$

In Equation 7, L₁ may mean a length of the curve calculated by the first function and

$${\int }_{0}^{a} \sqrt{1 + {( 2 {m}_{2} x )}^{2}} dx$$

may mean a length of the curve of the first function.

$${L}_{2} = a + b \qquad [ Equation 8 ]$$

In Equation 8, L₂ may mean a length of the curve calculated by the second function and a+b may mean a length of the curve of the second function. For reference, in the specification, for the convenience of description, a+b is described as a length of the curve, but the present disclosure is not limited thereto. For example, L₂ or a+b may mean a length of vertical processing for maximizing cooling performance of the brake pad 130.

$${L}_{n} = {sL}_{1} + {tL}_{2} = {\int }_{0}^{a} \sqrt{1 + {( {mnx}^{n - 1} )}^{2}} dx \qquad [ Equation 9 ]$$

In Equation 9, Ln may mean a length of the first curve, and sL₁+tL₂ may mean that a first weight (e.g., a weight of noise reduction) is applied to Equation 7 and a second weight (e.g., a cooling weight) of the brake pad 130 is applied to Equation 8. In detail, the first weight may refer to a noise decreasing weight and may mean a weight that may decrease noise of the brake pad 130. The second weight may refer to a cooling weight and may mean a weight that may increase the cooling effect of the brake pad 130. Each of the first weight and the second weight may satisfy a predetermined section (e.g., a section of 0 or more and 1 or less). Further, a result obtained by adding the first weight and the second weight may satisfy a predetermined value (e.g., one), but the present disclosure is not limited thereto.

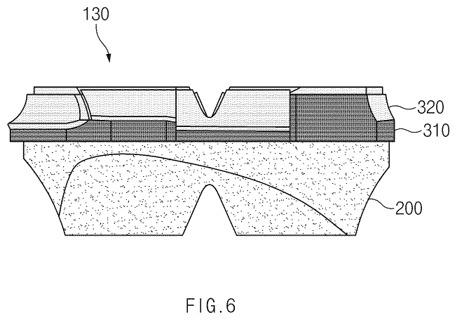

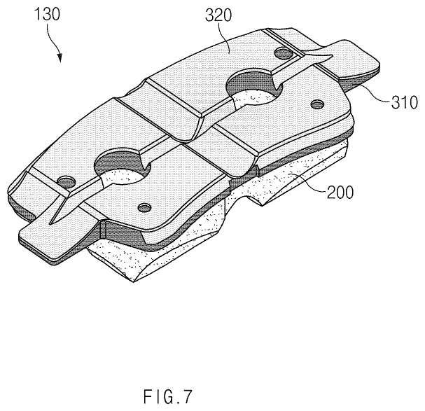

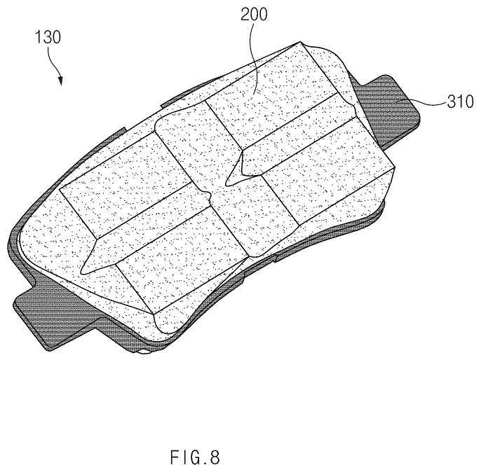

FIG. 6 is a side view of a brake pad according to an embodiment of the present disclosure. FIGS. 7 and 8 are perspective views of a brake pad according to an embodiment of the present disclosure.

FIG. 6 is a side view illustrating the brake pad 130. The brake pad 130 may include the frictional material 200, the lower layer 310 of the back plate 300, and the viscoelastic layer 320 (i.e., an upper layer of the back plate 300). For example, the back plate 300 may form the base of the brake pad 130. The frictional material 200 may be stacked on the lower end of the back plate 300 to generate the friction with the disc 120. The viscoelastic layer 320 may be stacked on an upper end of the lower layer 310 of the back plate 300 and reduce vibration of the back plate 300.

FIGS. 7 and 8 are perspective views illustrating the brake pad 130. For example, referring to FIG. 7, the back plate 300 may include at least one outer groove 450. If the back plate 300 includes the outer groove 450, the viscoelastic layer 320 may be formed at the upper end of the lower layer 310 of the back plate 300 in a form including the outer groove 450. Referring to FIG. 8, the frictional material 200 may include at least one inner groove 250.

The above description is merely illustrative of the technical spirit of the present disclosure. Those having ordinary skill in the art to which the present disclosure belongs may make various modifications and changes without departing from the essential features of the present disclosure.

An effect of a brake pad according to the present disclosure is described as follows.

According to at least one embodiment of the present disclosure, development costs of the brake pad may be reduced due to frequency avoidance between components included in the brake pad and addition of a damping member for an amplitude decrease to the brake pad.

Further, according to at least one embodiment of the present disclosure, a brake pad including a rim processed into a curved line based on a first function for suppressing reflected waves of a brake and a second function for cooling the brake may be provided, thereby suppressing squeal noise and the reflected waves of the brake.

In addition, various effects directly or indirectly identified though the present document may be provided.

As described above, although the embodiments have been described with the limited drawings, those or ordinary skill in the art may apply various technical modifications and variations based on this disclosure. For example, even though the described technologies are performed in an order different from the described method, and/or the described components such as a system, a structure, and a device are coupled or combined in a form different from the described method or are replaced or substituted by other components or equivalents, appropriate results may be achieved.

Therefore, other implementations, other embodiments, and equivalents to the claims also fall within the scope of the claims described below.

Thus, the embodiments disclosed in the present disclosure are not intended to limit the technological spirit of the present disclosure but are intended to help describe the present disclosure. The scope of the technical spirit of the present disclosure is not limited by these embodiments. The scope of protection of the present disclosure should be interpreted by the appended claims, and all embodiments within the scope of equivalents thereto should be interpreted as being included in the scope of the present disclosure.

What is claimed is:

1. A brake pad comprising:
a back plate forming a base; and
a frictional material stacked on a first surface of the back plate and positioned to generate friction with a brake disc,
wherein at least one of the frictional material or the back plate includes a groove configured to suppress waves generated by the brake pad during use.

2. The brake pad of claim 1, wherein:
the frictional material includes at least one inner groove including a shape recessed in a disc contacting surface of the frictional material in a direction toward an opposite back plate contacting surface of the frictional material; and
the back plate includes at least one outer groove including a shape recessed in a second surface of the back plate in the direction toward the frictional material.

3. The brake pad of claim 2, wherein each of the inner groove and the outer groove includes at least one of a first curve corresponding to a predetermined function, a second curve different from the first curve, or a linear line, or any combination thereof.

4. The brake pad of claim 3, wherein the first curve is determined based on a first function for suppressing reflected waves in the brake pad.

5. The brake pad of claim 3, wherein the first curve is determined based on a second function for cooling the brake pad.

6. The brake pad of claim 1, wherein the frictional material is shaped such that a perimeter of the disc contacting surface of the frictional material is located closer to a center of the brake pad than a perimeter of the back plate contacting surface of the frictional material on one side surface and on another side surface of the frictional material.

7. The brake pad of claim 2, wherein the back plate is shaped such that the second surface of the back plate is located closer to a center of the brake pad than the first surface of the back plate on one side surface and on another side surface of the back plate.

8. The brake pad of claim 2, wherein the back plate includes a viscoelastic layer stacked on the second surface of the back plate and configured to reduce vibration of the back plate.

9. The brake pad of claim 8, wherein the viscoelastic layer includes at least one of a viscoelastic layer made of rubber or a viscoelastic layer made of polyurethane, or any combination thereof.

10. The brake pad of claim 9, wherein the viscoelastic layer made of rubber comprises a layer including an adhesive, rubber, and a metal.

11. The brake pad of claim 9, wherein the viscoelastic layer made of polyurethane comprises a layer including an adhesive, polyurethane, and nanoclay.

12. The brake pad of claim 1, wherein the groove includes at least one of a first curve corresponding to a predetermined function, a second curve different from the first curve, or a linear line, or any combination thereof.

13. The brake pad of claim 12, wherein the first curve is determined based on a first function for suppressing reflected waves in the brake pad.

14. The brake pad of claim 12, wherein the first curve is determined based on a second function for cooling the brake pad.
